(19) United States
(12) Patent Application Publication
(10) Pub. No.: US 2005/0276745 A1
(43) Pub. Date: Dec. 15, 2005

(54) Method for producing an alpha - alumina powder

(75) Inventors: Hajime Maki, Niihama-shi (JP); Yoshiaki Takeuchi, Niihama-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Sumitomo Chemical Company, Limited

(21) Appl. No.: 11/148,602

(22) Filed: Jun. 9, 2005

(30) Foreign Application Priority Data
Jun. 15, 2004 (JP) 2004-176518
Dec. 22, 2004 (JP) 2004-370730

(51) Int. Cl. C01F 7/02

(52) U.S. Cl. 423/626

(57) ABSTRACT

A method for producing an α-alumina powder is provided. The method for producing an α-alumina powder comprises steps of (1) preparing a mixture of an aluminum hydrolysate, a seed crystal and water; (2) removing the water from the mixture; and (3) calcining the resultant, wherein the aluminum hydrolysate in the step (1) is produced by hydrolyzing an aqueous aluminum chloride solution under conditions of a pH of 5 or less and a temperature of 60° C. or less.

### FIELD OF THE INVENTION

The present invention relates to a method for producing an α-alumina powder, in more detail, to a method for producing an α-alumina powder having a high α-ratio and large BET specific surface area, to provide a small amount of α-alumina particle having necking.

### BACKGROUND OF THE INVENTION

An α-alumina powder is an aluminum compound represented by the formula Al₂O₃, and having a main crystal phase of α-phase. The α-alumina powder is widely used as a raw material to produce sintered bodies such as translucent tubes. In view of producing high-strength sintered bodies, the α-alumina powder having a high α-ratio and large BET specific surface area, to provide a small amount of α-alumina particle having necking.

As a method for producing an α-alumina powder, there is known a method of dispersing an aluminum hydrolysate obtained by hydrolyzing an aluminum nitrate and a seed crystal in water to form an aqueous mixture, removing water from the aqueous mixture to obtain a mixed powder and then calcining the mixed powder (A. Krell, NanoStructured Materials, Vol. 11, 1141 (1999)).

However, according to a conventional method, an α-alumina powder having a high α-ratio and large BET specific surface area, to provide a small amount of α-alumina particle having necking is not easily produced.

### SUMMARY OF THE INVENTION

The present inventors have investigated methods for producing an α-alumina powder having a high α-ratio and large BET specific surface area, to provide a small amount of α-alumina particle having necking, and resultantly completed the present invention.

The present invention provides a method for producing an α-alumina powder comprising steps of
(1) preparing a mixture of an aluminum hydrolysate, a seed crystal and water;
(2) removing the water from the mixture; and
(3) calcining the resultant,
   wherein the aluminum hydrolysate in the step (1) is produced by hydrolyzing an aqueous aluminum chloride solution under conditions of a pH of 5 or less and a temperature of 60° C. or less.

### DETAILED DESCRIPTION OF THE INVENTION

In the step (1), a mixture of an aluminum hydrolysate, a seed crystal and water, is prepared.

The aluminum hydrolysate is produced by a method of hydrolyzing an aqueous aluminum chloride solution under conditions of a pH of 5 or less and a temperature of 60° C. or less. The concentration of aluminum chloride in the aqueous aluminum chloride solution, is usually about 0.01 molar/L or more and saturated concentration or less. It is preferable that aluminum chloride is completely dissolved to water. The aqueous aluminum chloride solution usually has a pH of about 0 or more and about 2 or less. The aqueous aluminum chloride solution may contain a solvent which evaporate or decompose at calcination temperature. Examples of the solvent include organic polar solvents (for example, alcohols such as methanol, ethanol, propanol and isopropanol) and organic non-polar solvents (for example, carbon tetrachloride, benzene and hexane).

The hydrolysis may be carried out under condition of a pH of about 3 or more. The hydrolysis is preferably carried out by adding a base. It is preferable the base does not contain metal component. Examples of the base include strong bases such as ammonia or weak bases such as ammonium carbonate and ammonium hydrogencarbonate. The ammonia may be in form of gas or aqueous solution, preferably aqueous solution. When aqueous ammonia solution is used, the concentration of the ammonia, in terms of NH₃, is usually about 0.01 mol/L or more and saturated concentration or less.

The hydrolysis may be carried out under a condition that pH of the aqueous aluminum chloride solution is 5 or less; for example, that the aqueous aluminum chloride solution is placed in a vessel equipped with a pH meter, followed by being added with pre-adjusted amount of base under monitoring pH of the solution.

The hydrolysis may be carried out at a temperature of 60° C. or less, preferably 50° C. or less, more preferably 45° C. or less. The lower limit of hydrolysis temperature is usually not less than freezing point of the aqueous aluminum chloride solution, preferably 0° C. or more. To regulate the hydrolyzation temperature, the vessel containing the solution may be cooled or heated.

In case that the hydrolyzation is carried out by addition of a base, after addition of the base completed, the solution may be maintained at a temperature of not less than freezing point of the mixture of the aqueous aluminum chloride solution and the base, preferably 0° C. or more, and 60° C. or less, preferably 50° C. or less; and for the time of about 1 hour or more and about 72 hours or less.

The aluminum hydrolysate is usually insoluble to water, and the obtained mixture is in a state of sol or gel, or has a precipitate of hydrolysate.

The seed crystal is usually a particle made of metal compound. Examples of the metal compound include metal oxides such as alumina, iron oxide and chromium oxide. The seed crystal has an average particle diameter of usually about 0.01 μm or more, preferably about 0.05 μm or more and about 0.5 μm or less, BET specific surface area of usually about 12 m²/g or more, preferably about 15 m²/g or more and about 150 m²/g or less. It is preferable the seed crystal has a crystal structure of corundum and no bound water. Examples of the seed crystal include α-alumina, α-iron oxide and α-chromium oxide, preferable α-alumina. The amount of the seed crystal, in terms of metal oxide, is about 1 part by weight or more, preferably about 2 part by weight or more, more preferably about 4 part by weight or more, and about 50 part by weight or less, preferably about 40 part by weight or less, more preferably about 25 part by weight or less based on 100 parts by weight of total amount of the hydrolysate and the seed crystal,

The amount of water is about 150 parts by weight or more, preferably about 200 parts by weight or more, and about 1000 part by weight or less, preferably about 500 part by weight or less based on 100 parts by weight of total amount of the aluminum hydrolysate and the seed crystal.

In the preparation in the step (1), the order to mix an aluminum hydrolysate, a seed crystal and water is not limited. When an aluminum chloride is hydrolyzed, a mixture of water and hydrolysate is obtained, and then the seed crystal may be added to the mixture. Alternatively, a seed crystal may be added to an aqueous aluminum chloride solution, followed by the aluminum chloride being hydrolyzed to obtain a mixture of water, aluminum hydrolysate and seed crystal.

In case of adding a seed crystal to a mixture of water and hydrolysate or an aqueous aluminum chloride solution, the seed crystal in form of powder may be added to the mixture of water and hydrolysate or the aqueous aluminum chloride solution, or the seed crystal in form of powder may be dispersed in a solvent such as water, and then added to the mixture of water and hydrolysate or the aqueous aluminum chloride solution.

In case that a seed crystal is dispersed in a solvent, the seed crystal may be mixed with a solvent and the mixture is subjected to dispersing by using a ball mill, vibration mill, medium-agitating mill and the like. Examples of the solvent include water, organic polar solvents (for example, alcohols such as methanol, ethanol, propanol and isopropanol) and organic non-polar solvents (for example, carbon tetrachloride, benzene, hexane and the like). The dispersion may be carried out in the presence of an organic dispersant or pH regulator.

In the step (2), water is removed from the mixture prepared in the step (1). The removal may be usually carried out by evaporating water from the mixture in freeze-drying, vacuum drying and the like. The removal may be carried out under the conditions at temperature of from about 0° C. to about 100° C., and for about 10 minutes to about 10 hours.

In the step (3), the powder produced in the step (2) is calcined. The calcination is usually carried out at a temperature of about 600° C. or more, preferably about 700° C. or more, and about 1000° C. or less, preferably about 950° C. or less. The calcination is usually carried out at temperature rising rate of about 60° C./hr or more and about 1200° C./hr or less.

The temperature rising rate is, in the temperature range of from about 150° C. to about 600° C., preferably about 500° C./hr or less, more preferably about 60° C./hr or more and about 200° C./hr or less.

In the step (3), gases such as hydrogen chloride derived from a raw material such aluminum chloride may be generated. In this case, it is preferable that the powder produced in the step (2) powder is maintained at a temperature of about 600° C. or less until gas generation finishes, and then raised up about 600° C. or more. The calcination may be carried out under an air or inert gas. such as nitrogen gas and argon gas. The calcination may be also carried out under an atmosphere of low partial pressure of water vapor. The calcination may be carried out by using a furnace such as tubular electric furnace, box-type electric furnace, tunnel furnace, far-infrared furnace, microwave furnace, shaft furnace, reflection furnace, rotary furnace and Roller Hearth furnaces. Further, The calcination may be carried out in a batch-wise or continuous, and in static mode or flow mode.

The calcination time is time enough to transform the hydrolysate to an α-alumina powder, which depends on an amount of raw material(aluminum chloride), type of furnace, calcination temperature and calcination atmosphere, is usually about 10 minutes or more and about 24 hours or less.

In the present invention, the step (3) may be carried out after the step (2) without cooling down.

The α-alumina powder obtained by the step (3) may be pulverized. Pulverization may be carried out by using a medium pulverizer such as vibration mill and ball mill or jet mill. The α-alumina powder may be classified.

According to the above method, an α-alumina powder having an α-ratio of about 90% or more, preferably about 95% or more, and BET specific surface area of about 13 m²/g or more, preferably about 15 m²/g or more, and about 150 m²/g or less, preferably about 100 m²/g or less is obtained. The α-alumina powder has usually an average particle diameter of about 0.01 μm or more and about 0.2 μm or less,

The α-alumina powder is useful as a raw material for producing an α-alumina sintered body, for example a dense α-alumina sintered body having high strength and transparency. Further, the α-alumina powder is sintered at lower temperature than a conventional α-alumina powder.

### EXAMPLES

The present invention is described in more detail by following Examples, which should not be construed as a limitation upon the scope of the present invention.

α-Ratio (%):

It is calculated according to the following formula (1) using the peak intensity I_{25.6} at 2θ=25.6° and the peak intensity I₄₆ of at 2θ=46° from a diffraction spectrum obtained by using a powder X-ray diffractometer. The peak at 2θ=25.6° represents a peak of an alumina α phase (012) plane, and The peak at 2θ=46° represents a peak of alumina other than α-alumina.
α-ratio(%)=I_{25.6}/(I_{25.6}+I₄₆)×100(%) (1)
BET Specific Surface Area (m²/g):

It was measured by using specific surface area analyzer (trade name “FLOWSORB II 2300”, manufactured by Shimadzu Corporation) with a nitrogen adsorption method.

Degree of Necking:

Among 20 or more of particles on a transmission electron micrograph of α-alumina powder, the ratio of those in form of agglomerated two or more primary particles was calculated. The measuring method will be explained by following model diagram.

In the Diagram:
Particles in form of no agglomerated primary particles: 18
Particle in form of agglomerated two primary particles: 1
Particle in form of agglomerated three primary particles: 1
In this case, degree of necking was 10% [=2/(18+1+1)]
   Average Primary Particle Diameter (μm):

From a transmission electro micrograph of α-alumina powder, the maximum diameter along constant direction of each primary particle of any 20 or more was measured, and the average value of measured values was calculated.

### Example 1

[Production of Seed Crystal Slurry]

The aluminum hydroxide produced by hydrolyzing aluminum isopropoxide, was calcined to obtain a transition alumina having a main crystal phase of θ and content of α-phase of 3% by weight. The transition alumina was pulverized by using a jet mill to obtain powder having bulk density of 0.21 g/cm³.

The powder was continuously introduced into a furnace, of which atmosphere was filled with a dried air having dew point of −15° C. [partial pressure of water vapor of 165 Pa], and continuously drawn out from the furnace to be calcined at maximum temperature of 1170° C. for 3 hours of average retention time to obtain an α-alumina having a BET specific surface area of 14 m²/g. 100 parts by weight of the α-alumina was added with 1 part of weight of a pulverizing agent (propylene glycol) and further added with alumina beads having diameter of 15 mm, and the pulverized by using a vibration mill for 12 hours to obtain a seed crystal. The seed crystal had a BET specific surface area of 17.2 m²/g and average particle diameter of about 0.1 μm.

20 parts by weight of the seed crystal was added to 80 parts by weight of aqueous aluminum chloride solution (pH=2) and dispersed in the aqueous aluminum chloride solution. Further, the mixture is subjected to wet dispersion for 24 hours by using a ball mill with 700 g of alumina beads having a diameter of 2 mm to obtain a seed crystal slurry.

[Production of +-Alumina Powder]

241.3 g (1 mole) of aluminum chloride hexahydrate [AlCl₃.6H₂O] (manufactured by Wako Pure Chemical Industries, Ltd., special grade, powder) was dissolved in water to obtain 1 L of an aqueous aluminum chloride solution. 250 cm³ of the aqueous aluminum chloride solution was added with 7.1 g (1.4 g in terms of Al₂O₃) of the seed crystal slurry and mixed with 39.3 g (9.8 g in terms of NH₃) of 25% aqueous ammonia (manufactured by Wako Pure Chemical Industries, Ltd., special grade) at a feed rate of 4 g/minute by using a microrotary pump while agitating at 25° C. After the addition completed, a slurry containing a precipitate of aluminum hydrolysate was obtained. The slurry had a pH of 3.8. The slurry was maintained at 25° C. to be in form of gel and then placed in an air bath at 60° C. to evaporate water to obtain a powdery mixture.

An amount of the seed crystal in the powdery mixture is 10 parts by weight based on 100 parts by weight of the total amount of the powder mixture of aluminum hydrolysate and the seed crystal. The powdery mixture was deagglomerated in a mortar, and then charged into an alumina crucible, which was placed in a box-type electric furnace. The powdery mixture was heated from 25° C. up to 920° C. at a temperature rising rate of 300° C./hr under air atmosphere, and then calcined at this raised temperature for 3 hours to obtain an α-alumina powder. The α-alumina powder had an α-ratio of 97% and BET specific surface area of 14.2 m²/g, degree of necking of 31% and average primary particle diameter of 94 nm.

### Example 2

An α-alumina powder was obtained by the same operation as in Example 1 except that an amount of the seed crystal slurry was changed from 7.1 g to 27.3 g (1.4 g in terms of Al₂O₃), an amount of the 25% aqueous ammonia was changed from 9. 8 g to 41.2 g (10.3 g in terms of NH₃) and the powdery mixture was heated from 25° C. up to 880 ° C. at a temperature rising rate of 300° C./hr under air atmosphere, and then calcined at this raised temperature for 3 hours. In this example, an amount of the seed crystal in the powdery mixture is 10 parts by weight based on 100 parts by weight of the total amount of the powder mixture.

The α-alumina powder had an α-ratio of 99% and BET specific surface area of 18.9 m²/g, degree of necking of 11% and average primary particle diameter of 65 nm.

### Example 3

An α-alumina powder was obtained by the same operation as in Example 1 except that the powdery mixture was heated from 25° C. up to 500° C. at a temperature rising rate of 150° C./hr under air atmosphere, calcined at this raised temperature for 1 hour, cooled down to 25° C. and then heated up to 900° C. at a temperature rising rate of 300° C./hr, calcined at this raised temperature for 3 hours.

The α-alumina powder had an α-ratio of 97% and BET specific surface area of 17.9 m²/g, degree of necking of 24% and average primary particle diameter of 89 nm.

### Example 4

[Production of Seed Crystal Slurry]

20 parts by weight of the seed crystal having a BET specific surface area of 17.2 m²/g obtained by the same operation as in Example 1 was added to 80 parts by weight of aqueous aluminum chloride solution (pH=2) and dispersed in the aqueous aluminum chloride solution. The mixture is subjected to wet dispersion for 24 hours by using a wet disperser (trade name: DAYNOMILL, manufactured by Ashizawa K.K.) filled with 2.9 kg of alumina beads having a diameter of 0.65 mm ), classified by centrifugal separation under the condition of rotating speed: 4000 rpm (acceleration: about 2100 G) for 40 minutes, followed by the supernatant being removed to obtain a seed crystal slurry having solid concentration of 1.4 % by weight.

[Production of α-Alumina Powder]

101.2 g (1.4 g in terms of Al₂O₃) of the seed crystal slurry was mixed with 60.4 g (0.25 mole) of aluminum chloride hexahydrate [AlCl₃.6H₂O] (manufactured by Wako Pure Chemical Industries, Ltd., special grade, powder) and 173.8 g of water at 25° C. to obtain a mixture. 40.6 g (10.1 g in terms of NH₃) of 25% aqueous ammonia (manufactured by Wako Pure Chemical Industries, Ltd., special grade) was added to the mixture at a feed rate of 4 g/minute by using a microrotary pump while agitating at 25° C. After the addition completed, a slurry containing a precipitate of aluminum hydrolysate was obtained. The slurry had a pH of 4.2. The slurry was maintained at 25° C. to be in form of gel and then placed in an air bath at 60° C. to evaporate water to obtain a powdery mixture. The powdery mixture was deagglomerated in a mortar, and then charged into an alumina crucible, which was placed in a box-type electric furnace. The powdery mixture was heated from 25° C. up to 500° C. at a temperature rising rate of 150° C./hr under air atmosphere, calcined at this raised temperature for 1 hour, cooled down to 25° C. and then heated up to 880° C. at a temperature rising rate of 300° C./hr, calcined at this raised temperature for 3 hours.

The obtained α-alumina powder had an α-ratio of 97% and BET specific surface area of 20.5 m²/g, degree of necking of 0% and average primary particle diameter of 51 nm.

### Example 5

[Production of Seed Crystal Slurry]

10 parts by weight of the α-alumina powder obtained by the same operation as in Example 4 was added to 90 parts by weight of 0.01 mol/L aqueous aluminum chloride solution (pH=2) to obtain a mixture. The mixture was subjected to wet dispersion for 3 hours by using a batch-type sand grinder (type: 4TSG-1/7(1/8), rotating speed: 2000 rpm, manufactured by AIMEX CO., LTD.) filled with 760 g of alumina beads having a diameter of 0.65 mm under to obtain a seed crystal slurry. The seed crystal slurry had a alumina content of 10% by weight.

[Production of α-Alumina Particle]

60.1 g (0.25 mole) of aluminum chloride hexahydrate [AlCl₃.6H₂O] (manufactured by Wako Pure Chemical Industries, Ltd., special grade, powder) was mixed with 194.5 g of water and 14.2 g (1.4 g in terms of Al₂O₃) of the seed crystal to obtain a mixture. 43.9 g (11 g in terms of NH₃) of 25% aqueous ammonia (manufactured by Wako Pure Chemical Industries, Ltd., special grade) was added to the mixture with at a feed rate of 4 g/minute by using a microrotary pump while agitating at 25° C. to obtain a slurry. After the addition completed, the slurry had a pH of 4.2. The slurry was maintained at 25° C. to be in form of gel and then placed in an air bath at 60° C. to evaporate water. The obtained powdery mixture was deagglomerated in a mortar, and then charged into an alumina crucible, which was placed in a box-type electric furnace. The powdery mixture was heated from 25° C. up to 500° C. at a temperature rising rate of 150° C./hr under air atmosphere, calcined at this raised temperature for 1 hour, cooled down to 25° C. and then heated up to 900° C. at a temperature rising rate of 300° C./hr, calcined at this raised temperature for 3 hours.

The obtained α-alumina powder had an α-ratio of 98% and BET specific surface area of 17.8 m²/g, degree of necking of 0% and average primary particle diameter of 64 nm.

### Example 6

1030 g (11.3 g in terms of Al₂O₃)of the seed crystal slurry obtained in the same operation as [Production of seed crystal slurry] of Example 1 was mixed with 483 g (2 mole) of aluminum chloride hexahydrate [AlCl₃.6H₂O] (manufactured by YOTUHATA KAGAKU KOGYO K.K., powder) and 1030 g of water at 25° C. to obtain a mixture.

337.2 g (84.3 g of ammonia) of 25% aqueous ammonia (manufactured by Wako Pure Chemical Industries, Ltd., special grade) was added to the obtained a mixture at a feed rate of 19 g/minute by using a microrotary pump while agitating at 25° C. After the addition completed, a slurry containing a precipitate of aluminum hydrolysate was obtained. The slurry had a pH of 3.9. The slurry was maintained at 25° C. to be in form of gel.

The obtained gelated material was charged into a quartz vessel, which was placed in a box-type electric furnace. The gelated material was heated from 25° C. up to 500° C. at a temperature rising rate of 150° C./hr under air atmosphere, calcined at this raised temperature for 1 hour, cooled down to 25° C. and then heated up to 900° C. at a temperature rising rate of 300° C./hr, calcined at this raised temperature for 3 hours.

The obtained α-alumina powder had an α-ratio of 98% and BET specific surface area of 16.2 m²/g, degree of necking of 0% and average primary particle diameter of 72 nm.

### Example 7

[Production of α-Alumina Particle]

The gelated material obtained by the same operation as in Example 6 was maintained at 60° C. for 1 hour. Thereafter, 813 g of the gelated material was heated from 25° C. up to 500° C. at a temperature rising rate of 150° C./hr under air atmosphere, calcined at this raised temperature for 1 hour, cooled down to 25° C. and then heated up to 900° C. at a temperature rising rate of 300° C./hr, calcined at this raised temperature for 3 hours.

The obtained α-alumina powder had an α-ratio of 98% and BET specific surface area of 16.8 m²/g, degree of necking of 3% and average primary particle diameter of 67 nm.

1. A method for producing an α-alumina powder comprising steps of
(1) preparing a mixture of an aluminum hydrolysate, a seed crystal and water;
(2) removing the water from the mixture; and
(3) calcining the resultant,
wherein the aluminum hydrolysate in the step (1) is produced by hydrolyzing an aqueous aluminum chloride solution under conditions of a pH of 5 or less and a temperature of 60° C. or less.

2. The method according to claim 1, wherein the hydrolysis is carried out by adding a base.

3. The method according to claim 1, wherein the seed crystal is a metal oxide.

4. The method according to claim 1, wherein the seed crystal has a BET specific surface area of about 12 m²/g or more.

5. The method according to claim 1, wherein an amount of the seed crystal is about 1 part by weight based on 100 parts by weight of total amount of the aluminum hydrolysate and the seed crystal in terms of metal oxide.

6. The method according to claim 1, wherein an amount of the water in the step (1) is from about 150 parts to about 1000 parts by weight per based on 100 parts by weight of total amount of the aluminum hydrolysate and the seed crystal.

7. The method according to claim 1, wherein the calcination is carried out at from about 600° C. to about 1000° C.

8. The method according to claim 1, wherein the calcination is carried out at temperature rising rate of from about 60° C./hr to about 1200° C./hr.
